(19) United States
(12) Patent Application Publication
(10) Pub. No.: US 2013/0058404 A1
(43) Pub. Date: Mar. 7, 2013

(54) METHOD OF MOTION PREDICTION OF MULTIMEDIA VIDEO CODING

(71) Applicants: Jiun-In GUO, Chia-Yi County (TW); Ching-Lung Su, Yunlin County (TW); Hsiang-Chieh Kao, Taoyuan County (TW)

(72) Inventors: Jiun-In GUO, Chia-Yi County (TW); Ching-Lung Su, Yunlin County (TW); Hsiang-Chieh Kao, Taoyuan County (TW)

(21) Appl. No.: 13/223,469

(22) Filed: Sep. 1, 2011

(51) Int. Cl. H04N 7/26

(52) U.S. Cl. 375/240.12; 375/E07.104

(57) ABSTRACT

A method of motion prediction of multimedia video coding includes the steps of a) defining that each of macroblocks of enhancement layers has corresponding BL_Residual, EL_Residual, and EL_Residual_{ME}; b) acquiring the BL_Residual that the current macroblock corresponds to from one of the enhancement layers; c) identifying whether the BL_Residual is zero; if it is zero, apply the motion prediction of video coding to the current layer and then proceed to the step e); if it is not zero, proceed to the next step d); d) comparing the BL_Residual that the current macroblock corresponds to with a threshold; if the BL_Residual is smaller than the threshold, apply the motion prediction of video coding to the current layer; if the BL_Residual is bigger than the threshold, proceed to cross-layer-mode motion prediction of video coding; and e) ending.

### BACKGROUND OF THE INVENTION

1. Field of the Invention

The present invention relates generally to image processing, and more particularly, to a method of motion prediction of multimedia video coding.

2. Description of the Related Art

Scalable video coding (SVC) not only includes the high coding efficiency of the conventional H.264/AVC but enhances the encoding flexibility because SVC includes temporal scalability, spatial scalability, and signal to noise ratio (SNR) scalability. SVC is composed of a base layer and a plurality of enhancement layers. The coding of the base layer is similar to that of H.264/AVC, having lower resolution. The enhancement layer includes the same video content as the base layer and higher resolution. In addition to prediction and coding of the current (enhancement) layer, the coding of the base layer can be taken for cross-layer prediction and encoding, namely inter-layer prediction. As the source of the prediction increases, the computational complexity becomes more to further enable a device to require higher energy power. In need of low power and immediate communication for wireless device, SVC programming becomes more challenging.

The inter-layer prediction based on H.264/AVC includes three prediction modes: inter-layer intra prediction (ILIP), inter-layer motion prediction (ILMP), and inter-layer residual prediction (ILRP). Among the test modes, both of ILRP and inter mode of H.264/AVC of the current layer need motion prediction computation; for the enhancement layer, the motion prediction computation is the primary computational requirement of an encoder. If one motion prediction is selected from either two ones for prediction coding, 50% computational amount of motion prediction can be spared for software or hardware.

In the intra prediction of H.264/AVC, after motion prediction and motion compensation, the current macroblock can locate the most similar block in the reference frame and apply entropy coding to the residual between the current macroblock and the most similar block, i.e. subtraction of both, in the process of final coding, to get a film of complete coding and then the film is transmitted outward. However, the residual of the base layer is highly correlative to that of the enhancement layer of SVC, so it is necessary to minimize the residual of the enhancement layer by ILRP. The enhancement layer of the SVC can make the current macroblock correspond to the residual of the coded macroblock of the base layer, then apply SVC up-sampling to the corresponding block of the base layer according to the resolutions of the enhancement layer and the base layer, and finally deduct pixels that the residual of the macroblock of the base layer corresponds to after the up-sampling from pixels of the current macroblock of the enhancement layer, thus getting a search pattern of the cross-layer motion prediction from which the residual has been eliminated. In this way, the residual of the enhancement layer can be greatly decreased to further enhance the coding efficiency.

As indicated above, the difference between the search patterns of the cross-layer and the current layer in the enforcement layer can be found. The search pattern of the current layer is the current macroblock. The search pattern of the cross-layer is what the residue of the corresponding macroblock of the base layer after the up-sampling is deducted from each pixel value of the current macroblock. As the residual of the corresponding macroblock of the base layer after the up-sampling is smaller, the results of the motion predictions of the cross-layer and the current layer become closer to the same. As the residual of the corresponding macroblock of the base layer after the up-sampling is bigger, the results of the motion predictions of the cross-layer and the current layer become less identical. When video compression is carried out by other technology, up-sampling or down-sampling can also be applied to the raw image and the aforesaid motion prediction technology can also be applied to different inter modes.

### GLOSSARY

Residual: In one M×N pixel block, corresponding pixel value of a predetermined block is deducted from each pixel value of a raw block to get M×N values; the pixel block can be regarded as one of the aforesaid macroblocks. The residual is the sum of moduli of all pixel values of the M×N pixel block.

BL_Residual: In the macroblock of the base layer that the current macroblock of the enhancement layer corresponds to, it is each pixel value of the corresponding macroblock minus the corresponding pixel value of predicted macroblock and after up-sampling.

EL_Residual: It is each pixel value of the current macroblock minus the pixel value of the predicted macroblock after the enhancement layer is coded.

EL_Residual_{ME}: The motion prediction is applied to the current macroblock of the enhancement layer to come up with an optimal motion vector (MV). The motion compensation acquires the predicted macroblock according to the optimal MV and each pixel value of the current macroblock minus the corresponding pixel value of the predicted macroblock to get a residual of the enhancement layer under motion prediction.

### SUMMARY OF THE INVENTION

The primary objective of the present invention is to provide a method of motion prediction of multimedia video coding; the method can keep the quality and coding efficiency and save 50% software and hardware computational cost of motion prediction to further decrease the consumption of the computational energy.

The foregoing objective of the present invention is attained by the method having the steps of a) defining a multimedia video coding composed of a base layer and a plurality of enhancement layers of video and audio data, the base and enhancement layers having the same content but different resolutions, the base layer having the lowest resolution, each of the base and enhancement layers defining a plurality of macroblocks, defining the macroblock, which is being coded currently, as current macroblock, defining that each of the macroblocks in the enhancement layers has corresponding BL_Residual, EL_Residual, and EL_Residual_{ME}; b) acquiring the BL_Residual that the current macroblock corresponds to from one of the enhancement layers; c) identifying whether the BL_Residual is zero; if it is zero, apply the motion prediction of video coding to the current layers and then proceed to the step e); if it is not zero, proceed to the next step d); d) comparing the BL_Residual that the current macroblock corresponds to with a threshold, which is acquired by obtaining corresponding BL_Residual, EL_Residual, and EL_Residual_{ME} of multiple macroblocks adjacent to the current macroblock, randomly adding up and applying dynamic motion average computation or mean value computation to one or three of the BL_Residual, EL_Residual, and EL_Residual_{ME}, and finally applying a predetermined computation to the BL_Residual, EL_Residual, and EL_Residual_{ME}; if the BL_Residual is smaller than the threshold, apply the motion prediction of video coding to the current layer; if the BL_Residual is bigger than the threshold, proceed to cross-layer motion prediction of video coding; and e) ending.

### BRIEF DESCRIPTION OF THE DRAWINGS

FIG. 1 is a flow chart of a preferred embodiment of the present invention.

FIG. 2 is a schematic view of the preferred embodiment of the present invention, illustrating that up-sampling is applied to the current macroblock to get residual.

FIG. 3 is a schematic view of the preferred embodiment of the present invention, illustrating the status of the macroblock adjacent to the current macroblock.

### DETAILED DESCRIPTION OF PREFERRED EMBODIMENTS

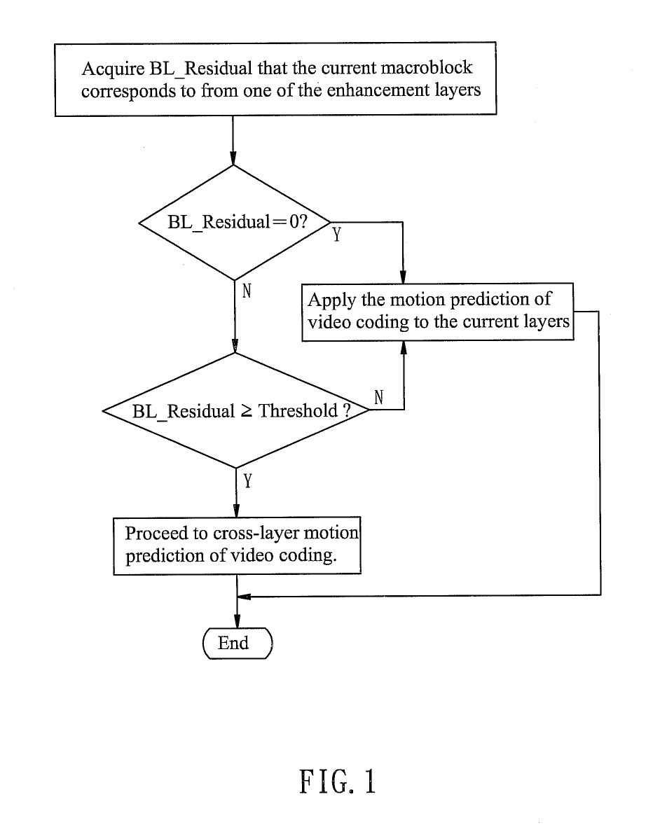

Referring to FIGS. 1-3, a method of motion prediction of multimedia video coding in accordance with a preferred embodiment of the present invention includes the following steps.

a) Define a multimedia video coding composed of a base layer and a plurality of enhancement layers of video and audio data. The base layer and the enhancement layer have the same content but different resolutions; the former has the lowest resolution. Each of the base layer and the enhancement layers defines a plurality of macroblocks therein. Define the macroblock which is being currently coded as the current macroblock 3. Define that each of the macroblocks of the enhancement layers includes corresponding BL_Residual, EL_Residual, and EL_Residual_{ME}.

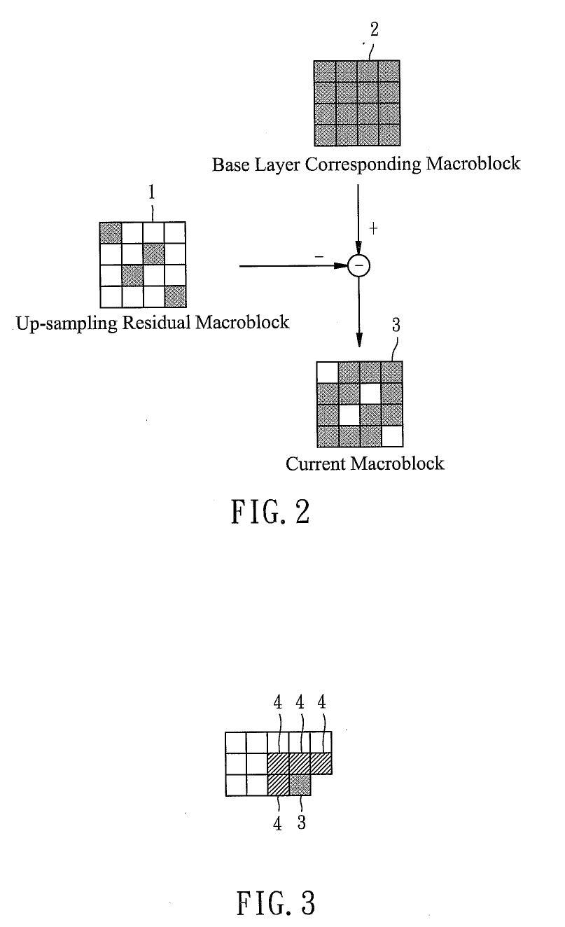

b) Get the BL_Residual in one of the enhancement layers that the current macroblock corresponds to. In FIG. 2, an up-sampling residual macroblock 1 is the residual acquired from the base layer corresponding macroblock 2 that the current macroblock 3 corresponds to after up-sampling.

c) Identify whether the BL_Residual is zero. If it is zero, apply the motion prediction of the video coding to the current layer and jump to the step e) of ending. If it is not zero, jump to the step d).

d) Compare the BL_Residual that the current macroblock 3 corresponds to with a threshold. If the BL_Residual is smaller than the threshold, apply the motion prediction of vide coding to the current layer. If the BL_Residual is bigger than or equal to the threshold, carry out the cross-layer motion prediction of vide coding. The threshold is acquired by obtaining corresponding BL_Residual, EL_Residual, and EL_Residual_{ME} of multiple adjacent macroblocks 4 to the current macroblock, randomly adding up and applying dynamic motion average computation or mean value computation to one or three of the BL_Residual, EL_Residual, and EL_Residual_{ME} to get average BL_Residual, average EL_Residual, and average EL_Residual_{ME}, and finally applying a predetermined computation to the average BL_Residual, the average EL_Residual, and the average EL_Residual_{ME}. In FIG. 3, the adjacent macroblocks 4 are located at the right, upper left, upper, and upper right sides of the current macroblock 3. The aforesaid predetermined computation is illustrated in the following step d1) as an example.

e) d1) Treat the ratio of the average BL_Residual to the average EL_Residual as an adjustment parameter. Adjusting the average EL_Residual_{ME} subject to the adjusting parameter. Add a user-defined offset into the adjusted the average EL_Residual_{ME} to get the threshold. The equation is shown below.

$$Threshold = \frac{BL\_Residual}{EL\_Residual} \times {EL\_Residual}_{ME} + Offset$$

f) End.

As indicated above, the present invention can apply determination to the BL_Residual that the current macroblock 3 corresponds to. When the BL_Residual is zero or smaller than the threshold, it is determined to apply the motion prediction of video coding to the current layer. When it is bigger than or equal to the threshold, it is determined to carry out the cross-layer motion prediction of video coding. In light of this, the present invention can select one of the current layer motion prediction and the cross-layer motion prediction and meanwhile keep the image quality and coding efficiency. Because the present invention cannot carry out both of the aforesaid computations, 50% computational cost can be spared to lower the consumption of computational energy.

Although the present invention has been described with respect to a specific preferred embodiment thereof, it is in no way limited to the specifics of the illustrated structures but changes and modifications may be made within the scope of the appended claims.

What is claimed is:

1. A method of motion prediction of multimedia video coding, comprising:
a) defining a multimedia video coding composed of a base layer and a plurality of enhancement layers of video and audio data, the base and enhancement layers having the same content but different resolutions, the base layer having the lowest resolution, each of the base and enhancement layers defining a plurality of macroblocks, defining a macroblock, which is being coded currently, as current macroblock, defining that each of the macroblocks in the enhancement layers has corresponding BL_Residual, EL_Residual, and EL_Residual_{ME};
b) acquiring the BL_Residual that the current macroblock corresponds to from one of the enhancement layers;
c) determining whether the BL_Residual is zero; if it is zero, apply the motion prediction of video coding to the current layer and then proceed to the step e); if it is not zero, proceed to the next step d);
d) comparing the BL_Residual that the current macroblock corresponds to with a threshold, which is acquired by obtaining corresponding BL_Residual, EL_Residual, and EL_Residual_{ME} of multiple macroblocks adjacent to the current macroblock, randomly adding up and applying dynamic motion average computation or mean value computation to one or three of the BL_Residual, EL_Residual, and EL_Residual_{ME} and finally applying a predetermined computation to the BL_Residual, EL_Residual, and EL_Residual_{ME}; if the BL_Residual is smaller than the threshold, apply the motion prediction of video coding to the current layer; if the BL_Residual is bigger than the threshold, proceed to cross-layer motion prediction of video coding; and
e) ending.

2. The method as defined in claim 1, wherein the predetermined computation can be carried out according to a step d1) of treating the ratio of the average BL_Residual to the average EL_Residual as an adjustment parameter, adjusting the average EL_Residual_{ME} subject to the adjusting parameter, and adding a user-defined offset into the adjusted average EL_Residual_{ME} to get the threshold.
